(19) United States
(12) Patent Application Publication
(10) Pub. No.: US 2009/0187945 A1
(43) Pub. Date: Jul. 23, 2009

(54) CUSTOMIZED ELECTRONIC PROGRAMMING GUIDE

(75) Inventor: Gregory Beck, Coppell, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/017,247

(22) Filed: Jan. 21, 2008

(51) Int. Cl. G06F 3/00

(52) U.S. Cl. 725/46

(57) ABSTRACT

A customizable electronic programming guide (CEPG) is hosted on a residential gateway. The CEPG includes user-defined folders that may be populated with other folders (i.e., sub-folders), program identifiers, or both. Electronic programming guide data arrive at the residential gateway in a standard form and are reformatted by the residential gateway for display according to the user-defined folders and sub-folders. In some embodiments, the CEPG is accessible by multiple set-top boxes that are communicatively coupled to the residential gateway. For ease of configuration, the residential gateway may provide access to a locally-hosted configuration web page.

### BACKGROUND

1. Field of the Disclosure

The present disclosure relates to the field of television service, and more particularly to a customized electronic programming guide.

2. Description of the Related Art

Users of television services are often provided with an electronic programming guide (EPG) that displays available programming. In some EPGs, available programming is listed according to channels that are shown in numerical order. Some EPGs allow users to select certain channels to be added to “favorites” lists.

### BRIEF DESCRIPTION OF THE DRAWINGS

FIG. 1 is a high-level view of a multimedia programming network;

FIG. 2A is a block diagram of a client configuration for use in a multimedia programming network;

FIG. 2B is a block diagram of an embodied residential gateway configured to provide a customized electronic programming guide;

FIG. 3 is a block diagram of a set-top box for use with a client of a multimedia programming network;

FIG. 4 is an example graphical user interface useful for classifying program identifiers; and

FIG. 5 is a functional flow chart of representative operations in an embodied method of providing a customized electronic programming guide.

### DESCRIPTION OF THE EMBODIMENT(S)

In one aspect, a customizable electronic programming guide (CEPG) is hosted on a residential gateway. The CEPG includes user-defined folders that may be populated with other folders (i.e., sub-folders), channel identifiers, or both. EPG guide data arrives at the residential gateway and is reformatted by the residential gateway for display according to the user-defined folders and sub-folders. In some embodiments, the CEPG is accessible by multiple set-top boxes that are communicatively coupled to the residential gateway. For ease of configuration, the residential gateway may provide access to a locally-hosted configuration web page.

In one aspect of the present specification, a user subscribes to a service, such as television service, provided over a multimedia programming network. A service provider may provide access to the network over various media such as cable, digital cable, satellite, and Internet protocol television (IPTV). The service provider provides a programming stream, including multimedia content and EPG data. EPG data may be received by an end-user device and parsed into channels. Each channel may correspond to an individual network available through the television service. For example, data representing programming available on networks such as ABC, CBS, NBC, and others may all be parsed into separate channels. A user may then be enabled to classify programming according to a hierarchical classification scheme. For example, at the top level of the hierarchy, the user may define the classes FAMILY, COMEDY, NEWS, EDUCATION, MOVIES, and RELIGIOUS. The user may then define sub-classes. For example, under the MOVIES class, the user may define the sub-classes DOMESTIC and FOREIGN. The number of hierarchical levels of classes may be limited to a discrete number, or further sub-classification may be enabled to any arbitrary number of levels. In some embodiments, classes at a hierarchical level may be graphically represented with folders, and sub-classes may be represented as sub-folders.

Once the user has defined a hierarchical classification scheme, the user can begin populating the classes. For example, in one embodiment, a graphical user interface (GUI) may be provided that presents a view of folders and sub-folders representing the classification hierarchy, and another view with a list of all available channels, each of which is identified by a channel identifier. The channel identifier may include a channel number, channel name, and/or channel call letters. The user may then be enabled to recognize desired channels by their channel identifiers and classify some or all of the channels by moving them to folders and sub-folders.

In some embodiments, the residential gateway, which enables communication between end-user devices and the multimedia programming network, provides the CEPG. This allows the CEPG to be configured and accessed on multiple set-top boxes, because each is connected to the residential gateway. The residential gateway may also be enabled with Internet protocol (IP) networking capabilities. In some embodiments, an IP-enabled residential gateway hosts an interactive web page over a wired or wireless home network. The interactive web page allows a user to define folders and sub-folders of programs, and to populate those folders and sub-folders with desired channels for each. In other embodiments, the residential gateway also provides a firewall connected to the Internet, and allows a user to access the interactive web page from any Internet connection. In this case, it may also be desirable to authenticate the user before allowing access to the interactive web page.

A CEPG will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 102-1 refers to an instance of a widget class, which may be referred to collectively as widgets 102 and any one of which may be referred to generically as a widget 102.

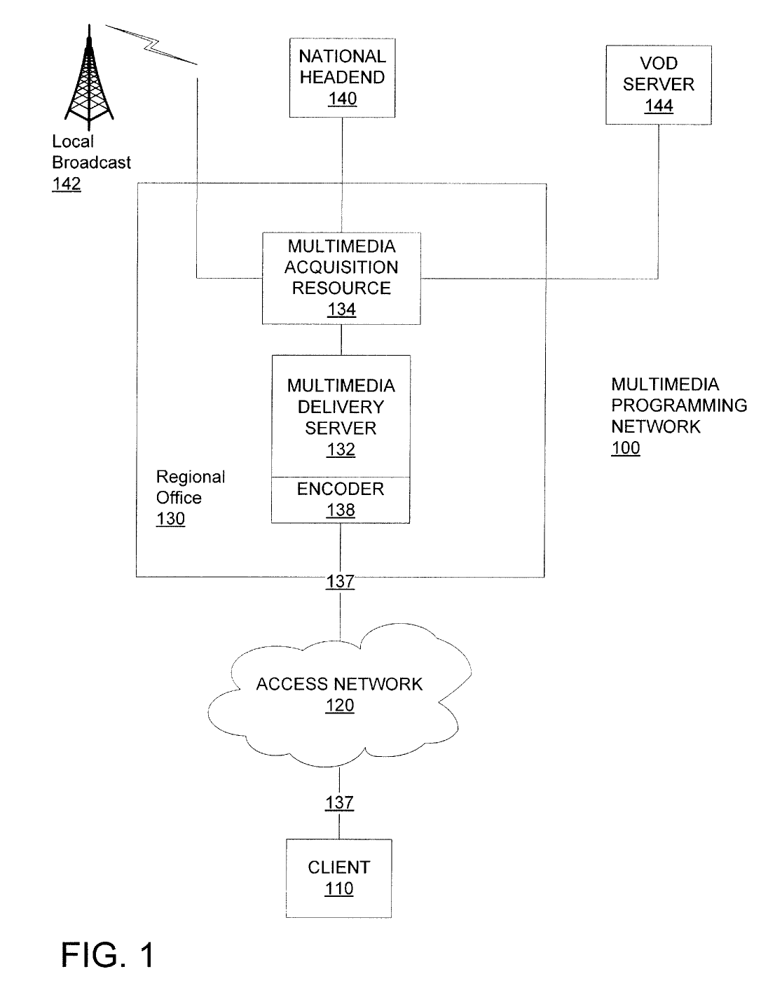

FIG. 1 illustrates a multimedia programming network 100. The network may receive programming from a plurality of sources, including a local broadcast 142, a national headend 140, or a video-on-demand (VOD) server 144. Programming from these various sources is collected by a regional office 130 operated by the multimedia programming service provider. The regional office 130 includes a multimedia acquisition resource 134, which is adapted to acquire the multimedia data. The multimedia acquisition resource 134 may then provide a consolidated multimedia stream to a multimedia delivery server 132. Alternatively, multimedia acquisition resource 134 may be an IPTV server, in which case it may provide only requested content on demand to multimedia delivery server 132. Multimedia delivery server 132 encodes the multimedia content within encoder 138, to provide encoded stream 137. Encoded stream 137 is delivered to access network 120, which may include delivery media such as broadcast, cable, digital cable, satellite, IPTV or fiber optic cables. Access network 120 delivers the encoded multimedia stream 137 to client 110, which may be operated by a user of the multimedia programming network.

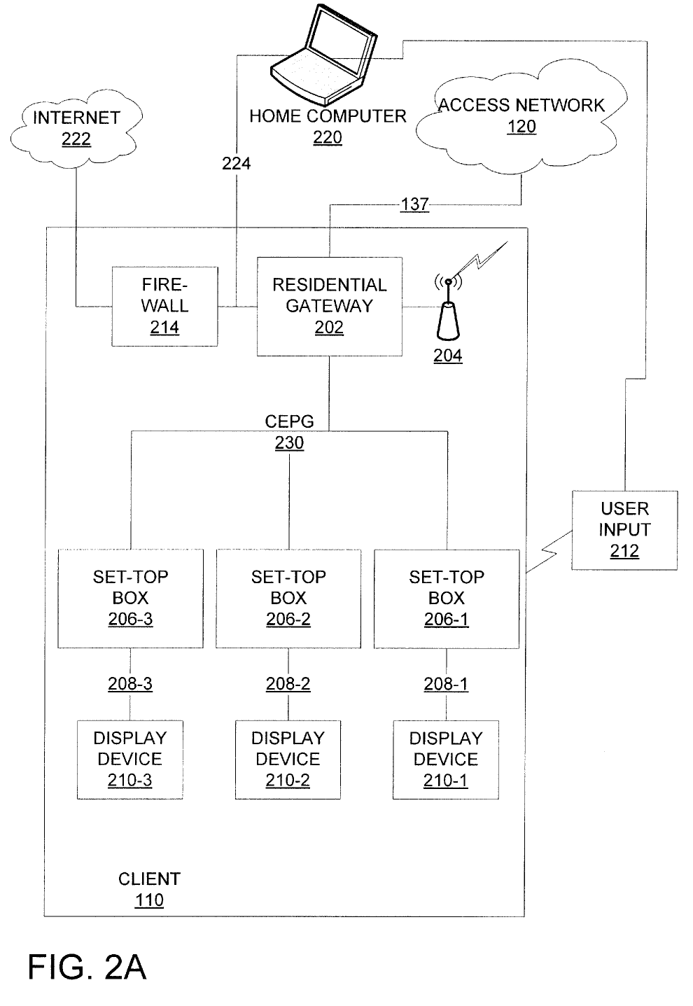

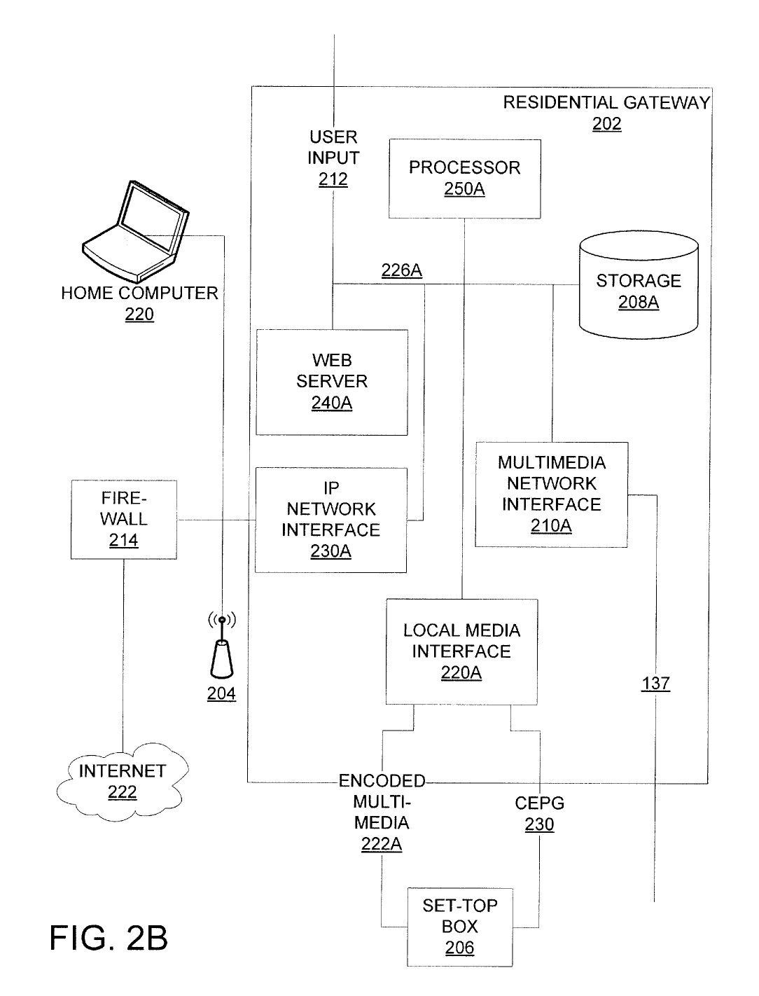

FIG. 2A illustrates client 110 in more detail. Encoded stream 137 is received by residential gateway 202. It should be understood that the term residential gateway 202 describes the function of the device, but is not intended to limit it to a particular type of device or specific item of hardware. Rather, residential gateway 202 may be any device that acts as the access point for client 110 in communicating with access network 120. The residential gateway may include instructions for creating and providing CEPG 230. It may then provide CEPG 230 to a set-top box 206. As is shown, a plurality of set-top boxes may receive the CEPG 230 from the residential gateway. Each set top box includes logic that accepts user input 212 from a device such as a remote control or from front panel buttons. Upon receiving user input 212, set-top box 206 may tune to a particular channel, decode the multimedia data for that channel, and provide a native-format multimedia stream 208 to a display device 210 such as a television. The native-format multimedia stream 208 may be in a commonly-used native format, such as phase alternating line (PAL) or national television system committee (NTSC), that is useful on display device 210. Set-top box 206 may also enable the user to manipulate the CEPG 230 and then provide the CEPG 230 back to the residential gateway 202. In this manner, any set-top box 206 will have access to the CEPG 230, regardless of which one created it.

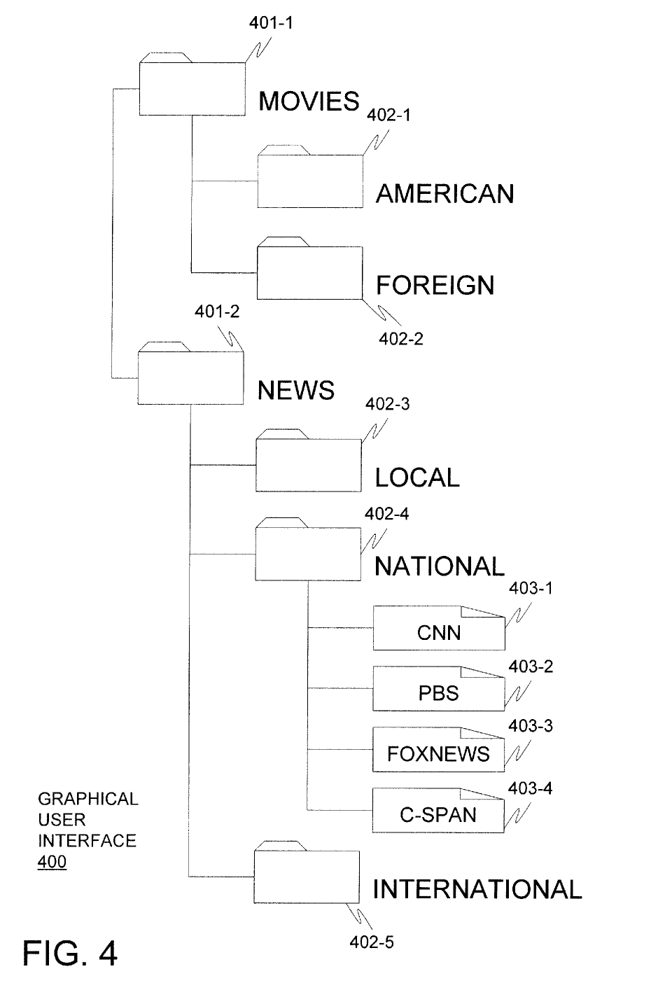

The residential gateway 202 may be connected to a number of devices adapted to communicate with it. For example, it may be in communication with a home computer 220, a wireless router 204, and a firewall 214. The home computer 220 and firewall 214 may be adapted to interface with residential gateway 202 either through a wired network connection 224, or through wireless router 204. In one embodiment, the residential gateway 202 provides an interactive web page that can be accessed through wired network connection 224 or through wireless router 204. The interactive web page may provide a GUI 400 (FIG. 4) for configuring the CEPG 230. The interactive web page may be provided on a private network address such as the 10.x.x.x block or the 192.168.x.x block in Internet protocol version 4. Firewall 214 may also be configured to provide access to the Internet 222. In this context, firewall 214 may be broadly understood to represent any device or capability that connects the local network to the Internet 222. In some embodiments, firewall 214 will require user authentication before allowing a user to access the interactive web page.

FIG. 2B illustrates in more detail a residential gateway 202 configured to provide a CEPG. The residential gateway 202 includes a processor 250A, which may be a central processor unit (CPU), application-specific integrated circuit (ASIC), field-programmable gate array (FPGA) or other programmable logic device. The processor 250A interfaces with a system bus 226A. As shown, system bus 226A provides communication between various components of the residential gateway 202. The processor 250A is configured to access storage 208A, which may be a hard disk, solid-state storage, or other storage medium. A multimedia network interface 210A provides an interface with the encoded stream 137 from the service provider. Multimedia network interface 210A may be internal to residential gateway 202, or may be an external peripheral. A web server 240A is provided as a hardware or software component in some embodiments that is enabled to create and transmit web pages, as well as process input received on web pages. An IP network interface 230A is configured to route web pages served by web server 240A to network devices. In some embodiments, web pages may be routed to home computer 220 and wireless router 204 (to which a home computer may be communicatively coupled). This configuration may allow a user to configure a CEPG through graphical means on a web browser. Furthermore, in some embodiments, a firewall 214 may be provided, which interfaces to Internet 222. This may make the interactive web page accessible to any node of the Internet 222. Local media interface 220A is configured to communicate with a set-top box 206 (FIG. 2A) and other local interface devices. Local media interface 220A provides both an encoded multimedia stream 222A and the CEPG 230. The residential gateway 202 may receive user input 212 and provide it to the processor 250A as configuration input. Configuration input instructs the processor 250A to create or update the CEPG 230. Configuration input may originate from a remote control, an interactive web page, or any other device or means adapted to act as a user interface.

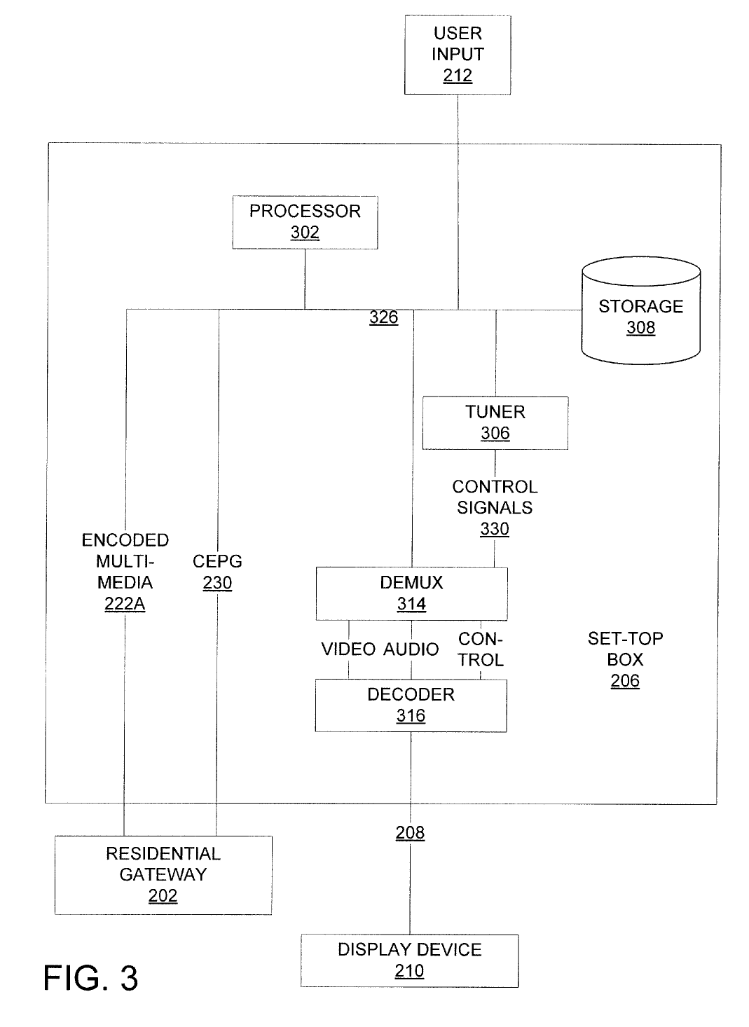

FIG. 3 illustrates a set-top box 206 configured for use with a CEPG 230. As shown, set-top box 206 is provided with a processor 302, which may be any of the types of devices discussed regarding residential gateway processor 250A (FIG. 2B). In some embodiments, the functionality of processor 302 may be provided by the same physical hardware as residential gateway processor 250A (FIG. 2B), though this is not required. As shown, processor 302 is communicatively coupled to storage 308. In some embodiments, storage 308 may be provided by the same physical device as residential gateway storage 208A (FIG. 2B), though this is not required. The processor 302 is connected to a bus 326, which may also be provided by the same hardware as residential gateway bus 226A (FIG. 2B). Bus 326 provides a logical connection to residential gateway 202 for receiving encoded multimedia stream 222A and CEPG 230. The processor 250A may receive user input 212, which in some embodiments may also include inputs to GUI 400 (FIG. 4). In some embodiments, and in particular with those that use multiplexed multimedia signals, processor 302 controls a tuner 306, which selects the desired content from among the entire available stream. The tuner 306 then provides control signals 330 to demultiplexer (DEMUX) 314. Decoder 316 decodes the encoded multimedia stream 222A into the proper format. DEMUX 314 provides the encoded audio and video data, as well as control signals, to decoder 316. In other embodiments, such as those providing IPTV, only the desired content is provided in encoded multimedia stream 222A, which may render the use of a tuner 306 and DEMUX 314 unnecessary. In these examples, the multimedia data stream may be provided directly to decoder 316. Decoder 316 may decode the stream into NTSC or PAL streams, suitable for use on display 210, which may be a television, a monitor, or any other means of providing visual and audio output or any analogous service. In some embodiments, the CEPG 230 will also be shown on display 210, possibly in response to user input 212.

FIG. 4 illustrates an example GUI 400 in which classes of programming are represented by selectable icons such as folders and subclasses are represented by selectable icons such as subfolders. As shown, GUI 400 includes top-level classes 401 including MOVIES 401-1 and NEWS 401-2. These top-level classes may have been manually specified by a user, provided as suggestions when the user first uses the software, or be provided as part of a template that the user may select as a starting point. The class MOVIES 401-1 is further subdivided into two sub-classes: AMERICAN 402-1 and FOREIGN 402-2. Likewise, the NEWS class 401-2 is divided into LOCAL 402-3, NATIONAL 402-4, and INTERNATIONAL 402-5 subclasses. Hereafter, a colon will be used as a delimiter between classes and sub-classes for simplified notation (for example, the subclass LOCAL under the class NEWS will be denoted by NEWS:LOCAL). Also seen in this figure is that several channels 403 have been assigned to the NEWS:NATIONAL class 402-4. In some embodiments, the subclasses 402 may be further divided at lower levels. For example, a user may divide the NEWS :NATIONAL class into NEWS:NATIONAL:CONSERVATIVE and NEWS:NATIONAL:LIBERAL to classify programs according to the user's impression of the programs' political leanings. Users wanting extreme granularity of classification may define even more levels of subclasses, just as a user of a computer file system is able to create many levels of subfolders under a given folder. Each of the channels 403 may be a program identifier that the user can select and manipulate in the process of creating a hierarchical classification scheme.

As disclosed, GUI 400 may provide the primary means by which a user interacts with the CEPG 230 and may provide two distinct functions. First, GUI 400 may be useful for creating and updating the CEPG 230. Second, GUI 400 may be useful for displaying and enabling the user to use the CEPG 230. In some contexts, GUI 400 may be provided as a number of separate GUIs. For example, in some embodiments, a GUI provided to home computer 220 as an interactive web page may be used to create and update the CEPG 230, while a separate GUI provided on display 210 may be used to enable the user to select programming while watching television.

In some embodiments, the program identifiers may be individual multimedia programs rather than channels 403. So GUI 400 may display not only the channels 403, but also a selection of the programs that will be provided on the channels 403. A user may then select and classify individual programs. For example, a user may find that LAW & ORDER, BOSTON LEGAL, CHEERS, THE TONIGHT SHOW, and GOOD MORNING AMERICA are available on one or more channels. The user may then classify LAW & ORDER and BOSTON LEGAL as DRAMA:LEGAL, CHEERS as COMEDY:SITCOM, THE TONIGHT SHOW as COMEDY:VARIETY, and GOOD MORNING AMERICA as NEWS:MORNING (these programs are referred to hereafter as classified programs). The processor 250A of the residential gateway 202 may then be adapted to scan all available channels and find any instances of the classified programs. When the user then selects the class DRAMA:LEGAL, any instances of LAW & ORDER and BOSTON LEGAL will be displayed, regardless of which channel they are being shown on. Similarly, if the user is interested in seeing different perspectives on the day's news, he may expand NEWS:NATIONAL:CONSERVATIVE and NEWS:NATIONAL:LIBERAL and collapse others. He will then be able to see what “conservative” and “liberal” news programs are available and select one.

As the user interacts with GUI 400, the folders representing classes may be collapsed and expanded in a manner similar to folders and subfolders in common computer file management software. Collapsing and expanding folders allows the user to view only the programming that interests him at the moment. For example, if the user is interested only in seeing what legal dramas are on right now, he may expand the DRAMA:LEGAL class and collapse all others.

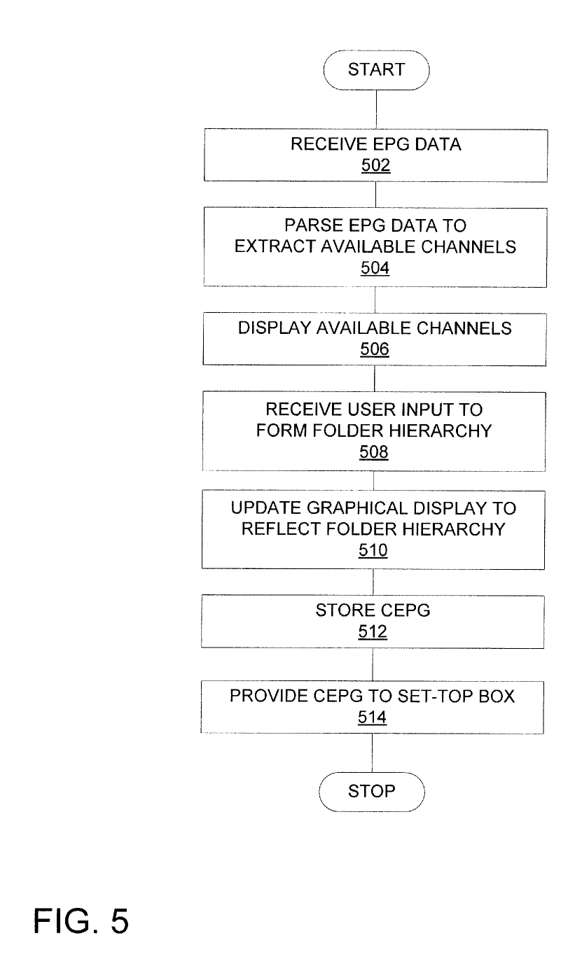

FIG. 5 is a flow chart describing the operation of a CEPG 230 (FIG. 2A). In block 502, EPG data is received. EPG data is parsed to extract available channels or programs in block 504. The available channels or programs are displayed in block 506, which may be done through one of the GUI means discussed above. User input is received in step 508, which may be received through any method described above. As the user manipulates icons and provides other input, the CEPG 230 (FIG. 2A) is updated accordingly. For example, classes or subclasses may be created and program identifiers may be assigned to certain classes or subclasses, or a user may manipulate an already-formed CEPG 230 to find a program. In some instances, block 508 may result in creation or modification of CEPG 230. In block 510, the GUI is updated to reflect any changes resulting from the input. In block 512, the CEPG is stored as described above. In block 514, the CEPG 230 (FIG. 2A) is provided to the set-top box for display to and use by the user.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. An apparatus for providing a customized electronic programming guide (CEPG), the apparatus comprising:
a processor communicatively coupled to a hardware interface for receiving electronic programming guide (EPG) data from a multimedia programming network, wherein the EPG data includes a plurality of program identifiers;
wherein the processor is adapted to receive configuration input for arranging a portion of the plurality of program identifiers in a hierarchical structure within the CEPG; and
wherein the configuration input includes instructions to result in the CEPG.

2. The apparatus of claim 1, wherein the apparatus is a residential gateway, wherein the residential gateway hosts the CEPG.

3. The apparatus of claim 2, wherein the configuration input specifies a hierarchical structure for arranging the EPG data to result in the CEPG.

4. The apparatus of claim 3, wherein the hierarchical structure includes a plurality of class icons and a plurality of subclass icons, wherein the configuration input specifies a portion of the subclass icons for associating within one or more of the plurality of class icons.

5. The apparatus of claim 4, wherein the configuration input further specifies a portion of the program identifiers for associating within one or more of the subclass icons.

6. The apparatus of claim 5, wherein the configuration input further specifies a portion of the program identifiers for associating within one or more of the class icons.

7. The apparatus of claim 6, wherein the program identifiers are selectable icons.

8. The apparatus of claim 7, wherein the CEPG is configured according to a template hosted by the residential gateway.

9. The apparatus of claim 8, wherein the configuration input is received through an interactive web page hosted by the residential gateway.

10. The apparatus of claim 9, wherein the interactive web page is accessible through the multimedia service provider network.

11. The apparatus of claim 10, wherein the residential gateway is adapted for communication with a plurality of set-top boxes, wherein the CEPG is accessible by the plurality of set-top boxes.

12. A software program stored on one or more computer readable media, the software program comprising instructions to:
receive electronic programming guide (EPG) data;
present the EPG data to a user;
receive from the user commands to classify the EPG data;
classify the EPG data in a hierarchical structure according to the commands from the user to result in classified EPG data; and
present the classified EPG data to the user.

13. The software program of claim 12 wherein the instructions to receive commands include instructions to:
provide an interactive web page; and
collect the commands from the user through the interactive web page.

14. The software program of claim 12 wherein:
the instructions to present the EPG data to a user include instructions to:
present a plurality of program identifiers received with the EPG data;
present a first portion of the plurality of program identifiers within a first class at a first hierarchical level; and
present a second portion of the plurality of program identifiers within a second class at a second hierarchical level.

15. The software program of claim 14 further comprising instructions to:
enable the user to define a subclass at a hierarchical level subordinate to the first class.

16. The software program of claim 15 wherein:
the first hierarchical level is graphically represented by a folder; and
the subordinate hierarchical level is graphically represented by a sub-folder.

17. A method of creating a customized electronic programming guide (CEPG) comprising:
receiving electronic programming guide (EPG) data;
receiving user input;
in accordance with the user input, classifying a program identifier to create a programming class; and
storing the programming class on a residential gateway.

18. The method of claim 17 wherein receiving input instructions comprises:
providing a graphical user interface configured to be hosted on a set-top box; and
receiving input values directed from a remote control device to the set-top box.

19. The method of claim 17 wherein receiving input instructions comprises:
providing an interactive web page configured to be hosted on the residential gateway and provided over a network; and
collecting input values from the interactive web page.

20. The method of claim 19 wherein the interactive web page is provided over an Internet connection.

21. A customizable electronic programming guide (CEPG) service for a user of a multimedia programming service, the service comprising:
enabling a residential gateway to receive electronic programming guide (EPG) data;
causing the residential gateway to provide the EPG data;
enabling a user to manipulate the EPG data into classes;
storing the classes on a storage device; and
enabling the user to view the classes.

22. The service of claim 21 wherein causing the residential gateway to display the EPG data comprises providing the data to an interactive web page.

23. The service of claim 22 wherein the interactive web page is hosted on a local network.

24. The service of claim 23 wherein the local network is a wireless network.

25. The service of claim 21 wherein causing the residential gateway to display the EPG data comprises providing the data as a graphical user interface configured for use through a set-top box.
